(19) United States
(12) Patent Application Publication
(10) Pub. No.: US 2026/0107281 A1
(43) Pub. Date: Apr. 16, 2026

(54) TECHNIQUES FOR BINARY PHASE SHIFT KEYING FOR CONTROL CHANNEL RESILIENCE AGAINST PHASE ERROR

(71) Applicant: QUALCOMM Incorporated, San Diego, CA (US)

(72) Inventors: Mahmoud TAHERZADEH BOROUJENI, San Diego, CA (US); Pinar SEN, San Diego, CA (US); Wei YANG, San Diego, CA (US); Tao LUO, San Diego, CA (US); Kirill IVANOV, La Jolla, CA (US)

(21) Appl. No.: 18/911,907

(22) Filed: Oct. 10, 2024

(51) Int. Cl. H04W 72/231; H04L 1/00; H04L 27/10

(52) U.S. Cl. CPC H04W 72/231; H04L 1/0071; H04L 27/10

(57) ABSTRACT

Various aspects of the present disclosure generally relate to wireless communication. In some aspects, a user equipment (UE) may receive a physical downlink control channel (PDCCH) transmission. The UE may demodulate the PDCCH transmission in accordance with a binary phase shift keying (BPSK) modulation scheme based at least in part on the PDCCH transmission having an aggregation level that satisfies a threshold. Numerous other aspects are described.

### FIELD OF THE DISCLOSURE

Aspects of the present disclosure generally relate to wireless communication and specifically relate to techniques, apparatuses, and methods associated with binary phase shift keying (BPSK) for control channel resilience against phase error.

### DESCRIPTION OF RELATED ART

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a method of wireless communication performed by a user equipment (UE). The method may include receiving a physical downlink control channel (PDCCH) transmission. The method may include demodulating the PDCCH transmission in accordance with a binary phase shift keying (BPSK) modulation scheme based at least in part on the PDCCH transmission having an aggregation level that satisfies a threshold.

Some aspects described herein relate to a method of wireless communication performed by a network node. The method may include modulating a PDCCH transmission using BPSK modulation based at least in part on the PDCCH transmission having an aggregation level that satisfies a threshold. The method may include transmitting the PDCCH transmission.

Some aspects described herein relate to a UE for wireless communication. The UE may include one or more memories and one or more processors coupled to the one or more memories. The one or more processors may be configured to receive a PDCCH transmission. The one or more processors may be configured to demodulate the PDCCH transmission in accordance with a BPSK modulation scheme based at least in part on the PDCCH transmission having an aggregation level that satisfies a threshold.

Some aspects described herein relate to a network node for wireless communication. The network node may include one or more memories and one or more processors coupled to the one or more memories. The one or more processors may be configured to modulate a PDCCH transmission using BPSK modulation based at least in part on the PDCCH transmission having an aggregation level that satisfies a threshold. The one or more processors may be configured to transmit the PDCCH transmission.

Some aspects described herein relate to a non-transitory computer-readable medium that stores a set of instructions for wireless communication by a UE. The set of instructions, when executed by one or more processors of the UE, may cause the UE to receive a PDCCH transmission. The set of instructions, when executed by one or more processors of the UE, may cause the UE to demodulate the PDCCH transmission in accordance with a BPSK modulation scheme based at least in part on the PDCCH transmission having an aggregation level that satisfies a threshold.

Some aspects described herein relate to a non-transitory computer-readable medium that stores a set of instructions for wireless communication by a network node. The set of instructions, when executed by one or more processors of the network node, may cause the network node to modulate a PDCCH transmission using BPSK modulation based at least in part on the PDCCH transmission having an aggregation level that satisfies a threshold. The set of instructions, when executed by one or more processors of the network node, may cause the network node to transmit the PDCCH transmission.

Some aspects described herein relate to an apparatus for wireless communication. The apparatus may include means for receiving a PDCCH transmission. The apparatus may include means for demodulating the PDCCH transmission in accordance with a BPSK modulation scheme based at least in part on the PDCCH transmission having an aggregation level that satisfies a threshold.

Some aspects described herein relate to an apparatus for wireless communication. The apparatus may include means for modulating a PDCCH transmission using BPSK modulation based at least in part on the PDCCH transmission having an aggregation level that satisfies a threshold. The apparatus may include means for transmitting the PDCCH transmission.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example resource structure for control channel transmissions, in accordance with the present disclosure.

FIG. 4 is a diagram illustrating an example of interleaving for control channel transmissions, in accordance with the present disclosure.

FIG. 5 is a diagram illustrating an example of BPSK for control channel resilience against phase error, in accordance with the present disclosure.

FIG. 6 is a diagram illustrating an example process performed, for example, at a UE or an apparatus of a UE, in accordance with the present disclosure.

FIG. 7 is a diagram illustrating an example process performed, for example, at a network node or an apparatus of a network node, in accordance with the present disclosure.

FIG. 8 is a diagram of an example apparatus for wireless communication, in accordance with the present disclosure.

FIG. 9 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In a wireless network, a transmitter may modulate a signal to be transmitted using a modulation scheme, such as binary phase shift keying (BPSK), quadrature phase shift keying (QPSK), 16 quadrature amplitude modulation (QAM), 64 QAM, or 256 QAM, among other examples. Each modulation scheme is associated with a modulation order, often denoted Qm, which quantifies the capacity associated with a single modulation symbol. In other words, the modulation order, or Qm value, equals the number of source bits that can be transmitted per modulated symbol. For example, BPSK can be used to transmit one source bit per modulated symbol (Qm=1), QPSK can be used to transmit two source bits per modulated symbol (Qm=2), and 16 QAM can be used to transmit four source bits per modulated symbol (Qm=4), among other examples. Modulation schemes associated with higher modulation orders can be used to transmit relatively more bits per symbol, which can result in higher throughputs, but modulation schemes associated with higher modulation orders are also more susceptible to noise and interference. Accordingly, physical uplink shared channel (PUSCH) and physical downlink shared channel (PDSCH) transmissions support various modulation schemes (e.g., QPSK or higher), where high modulation orders may be used to achieve high throughputs in good coverage conditions, while low modulation orders may be used to maximize coverage or improve reliability in poor coverage conditions.

Furthermore, physical downlink control channel (PDCCH) transmissions are performed using only QPSK to ensure reliable reception across an entire coverage area and to improve spectral efficiency by transmitting two bits per symbol (e.g., to efficiently and reliably convey signaling information without consuming significant bandwidth). For example, a PDCCH transmission may include one or more control channel elements (CCEs), where each CCE includes six resource element groups (REGs) and one REG is defined as one physical resource block (PRB), or 12 subcarriers, in one orthogonal frequency division multiplexing (OFDM) symbol. Accordingly, a PDCCH transmission may be associated with an aggregation level (AL), which generally corresponds to the number of CCEs in the PDCCH transmission, where up to 8 CCEs (e.g., a PDCCH transmission with an AL up to 8) can be encoded using a single polar code that provides forward error correction (FEC). For a PDCCH transmission with a larger AL (e.g., higher than 8), the PDCCH transmission may include multiple repetitions at an AL up to 8 (e.g., two repetitions at an AL of 8 may be used for PDCCH transmission with an AL of 16). For large ALs, which correspond to low coding rates, using repetitions and a smaller code block does not cause significant performance loss relative to using a single larger code block without repetitions.

Accordingly, as described herein, a higher AL may be used for a PDCCH transmission to increase the number of CCEs that are included in the PDCCH transmission, which may improve a link budget and enhance coverage. However, when a high AL is used in a channel with a low signal-to-noise ratio (SNR), there may be phase noise that results in non-ideal channel estimation that can degrade performance considerably. For example, non-ideal channel estimation can introduce phase error that may degrade PDCCH performance by about two to three decibels (dB), which can result in PDCCH decoding errors. Furthermore, the phase error has an adverse impact that generally depends on a distance between modulation points in phase. For example, in phase shift keying (PSK) modulation schemes such as BPSK, QPSK, and 8-PSK, modulation points are often represented on a constellation diagram in a complex plane, where a horizontal axis may represent a real or in-phase component of a signal and a vertical axis may represent an imaginary or quadrature component of the signal. The amplitude of each point along the in-phase axis is used to modulate a cosine wave, and the amplitude of each point along the quadrature axis is used to modulate a sine wave. The modulation points (or constellation points) are typically positioned with a uniform angular spacing around a circle centered at the intersection of the in-phase and quadrature axes, which provides a maximum separation between adjacent points and therefore a maximum resilience against phase error. Accordingly, because BPSK uses two phases that are separated by 180 degrees, and QPSK uses four phases that are separated by 90 degrees, BPSK can handle higher noise levels or distortion and provide better resilience against phase error compared to QPSK. However, because BPSK can only modulate one bit per symbol, PDCCH transmissions are transmitted using QPSK in order to double the BPSK data rate while maintaining the same bandwidth, or to maintain the BPSK data rate while halving the required bandwidth, despite the increased risk of PDCCH decoding errors due to phase noise.

Various aspects described herein generally relate to using BPSK modulation for control channel transmissions, such as PDCCH transmissions, to provide improved resilience against phase error. More particularly, for a Gaussian channel (e.g., where transmitted signals have a Gaussian distribution), two code block repetitions over QPSK symbols can be considered similar to transmitting a single larger code block over BPSK symbols (e.g., a QPSK signal used to modulate two bits can be viewed as similar or equivalent to two independent BPSK signals that each modulate one bit). Accordingly, in some aspects, a PDCCH transmission may be modulated using BPSK rather than QPSK based at least in part on one or more parameters associated with the PDCCH transmission. For example, in some aspects, the PDCCH transmission may be modulated using BPSK in accordance with an AL, a downlink control information (DCI) size, an REG bundle size, and/or a channel estimation configuration associated with the PDCCH transmission. Additionally, or alternatively, the PDCCH transmission may be modulated using BPSK in accordance with the AL satisfying (e.g., equaling or exceeding) a threshold, where a value of the threshold may be fixed, configured by a network node, and/or dependent on the DCI size, the REG bundle size, the channel estimation configuration, and/or other suitable parameters associated with the PDCCH transmission. Additionally, or alternatively, in some aspects, the PDCCH transmission may be modulated using twisted BPSK, or rotated QPSK on two resource elements (REs). For example, when a channel is associated with two independent QPSK symbols that are different from each other, a two-symbol unitary rotation may be used to couple the two independent QPSK symbols to improve usage of frequency diversity. Accordingly, when the twisted BPSK or rotated QPSK modulation is used, real and imaginary components of a rotated QPSK symbol may be transmitted on two REs from two different CCEs and/or two different REG bundles.

Particular aspects of the subject matter described in this disclosure can be implemented to realize one or more of the following potential advantages. In some examples, by using BPSK modulation for a PDCCH transmission in cases where QPSK modulation may result in non-ideal channel estimation (e.g., when the PDCCH transmission has a high AL, has a large DCI size, or is otherwise associated with parameters that introduce phase errors due to the distance between the QPSK modulation points in phase), the described techniques may exploit the 180 degree separation between modulation points in BPSK modulation to mitigate the adverse effects associated with channel estimation errors in PDCCH performance. Additionally, or alternatively, by using the twisted BPSK or rotated QPSK modulation to transmit the real and imaginary components of a rotated QPSK symbol on two REs, the described techniques may exploit frequency diversity to further reduce the adverse effects associated with channel estimation errors and improve PDCCH performance (e.g., by mixing two different channel gains and/or the effect of two different levels of channel estimation noise to reduce PDCCH decoding errors in a frequency selective channel).

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

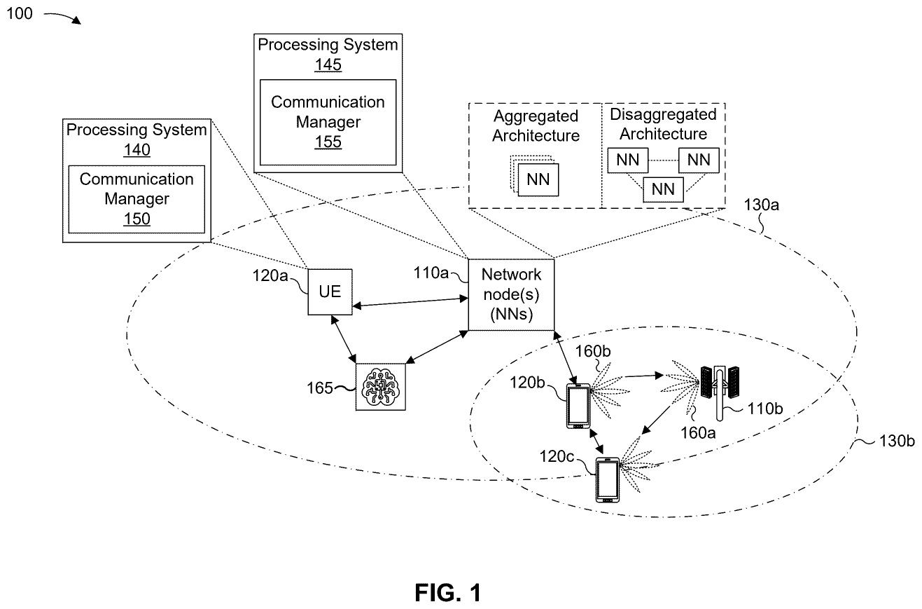

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A processing system (e.g., the processing system 140 and/or the processing system 145) may generally be a system or a series of machines or components that receives inputs and processes the inputs to produce a set of outputs (which may be passed to other systems or components of, for example, the UE 120). For example, the processing system 140 of the UE 120 may be a system that includes the various other components or subcomponents of the UE 120. The processing system 140 of the network node 110 may be a system that includes the various other components or subcomponents of the network node 110.

The processing system 145 of the network node 110 may interface with one or more other components of the network node 110, may process information received from one or more other components (such as inputs or signals), or may output information to one or more other components. For example, a chip or modem of the network node 110 may include the processing system 145, a first interface to receive or obtain information, and a second interface to output, transmit, or provide information. In some examples, the first interface may be an interface between the processing system 145 of the chip or modem and a receiver, such that the network node 110 may receive information or signal inputs, and the information may be passed to the processing system 145. In some examples, the second interface may be an interface between the processing system 145 of the chip or modem and a transmitter, such that the network node 110 may transmit information output from the chip or modem. Similarly, the processing system 140 of the UE 120 may interface with one or more other components of the UE 120, may process information received from one or more other components (such as inputs or signals), or may output information to one or more other components. For example, a chip or modem of the UE 120 may include the processing system 140, a first interface to receive or obtain information, and a second interface to output, transmit, or provide information. In some examples, the first interface may be an interface between the processing system 140 of the chip or modem and a receiver, such that the UE 120 may receive information or signal inputs, and the information may be passed to the processing system 140. In some examples, the second interface may be an interface between the processing system 140 of the chip or modem and a transmitter, such that the UE 120 may transmit information output from the chip or modem. A person having ordinary skill in the art will readily recognize that the second interface described above also may obtain or receive information or signal inputs, and the first interface described above may also may output, transmit, or provide information.

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

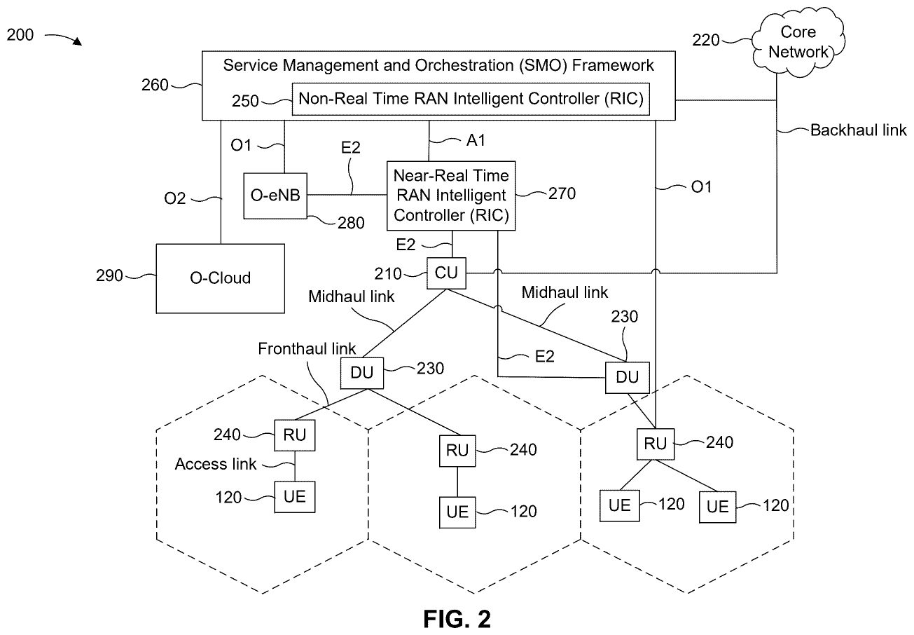

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a DCI configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include PDCCHs, and downlink data channels may include PDSCHs. Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include PUSCHs. Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of QAM, such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or an FEC operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, the UE 120 may include a communication manager 150. As described in more detail elsewhere herein, the communication manager 150 may receive a PDCCH transmission; and demodulate the PDCCH transmission in accordance with a BPSK modulation scheme based at least in part on the PDCCH transmission having an aggregation level that satisfies a threshold. Additionally, or alternatively, the communication manager 150 may perform one or more other operations described herein.

In some aspects, the network node 110 may include a communication manager 155. As described in more detail elsewhere herein, the communication manager 155 may modulate a PDCCH transmission using BPSK modulation based at least in part on the PDCCH transmission having an aggregation level that satisfies a threshold; and transmit the PDCCH transmission. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers.

Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

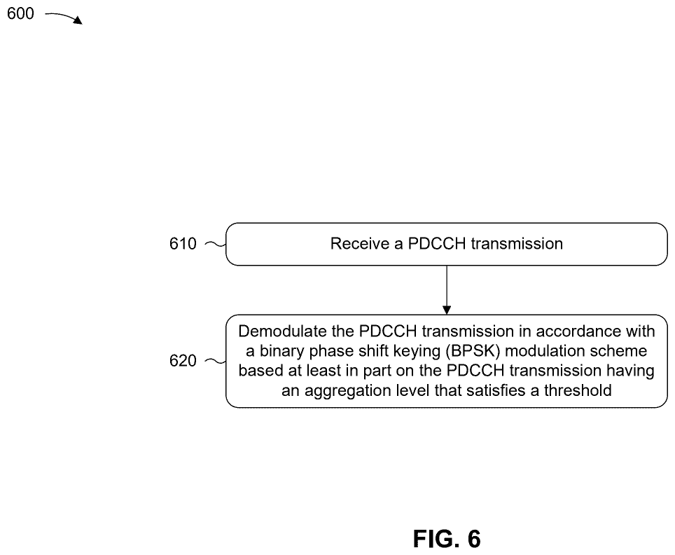

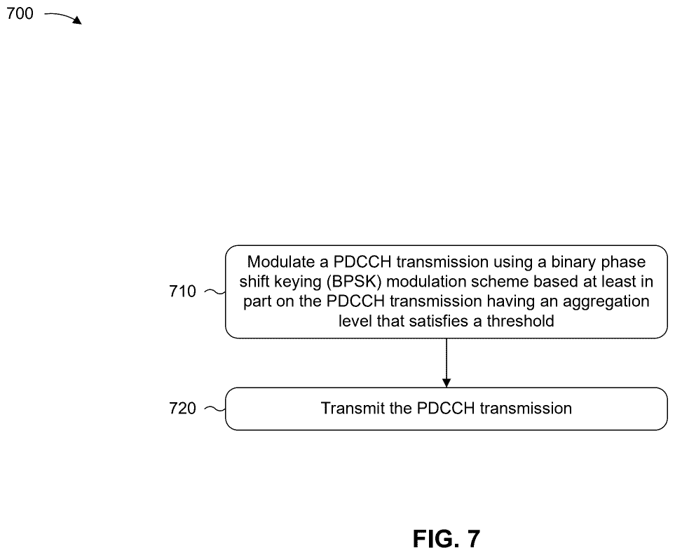

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with BPSK for control channel resilience against phase error, as described in more detail elsewhere herein. For example, the processing system 145 of the network node 110, the processing system 140 of the UE 120, the CU 210, the DU 230, or the RU 240 may perform or direct operations of, for example, process 600 of FIG. 6, process 700 of FIG. 7, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 600 of FIG. 6, process 700 of FIG. 7, or other processes as described herein. In some examples, executing instructions may include running the instructions, converting the instructions, compiling the instructions, and/or interpreting the instructions, among other examples.

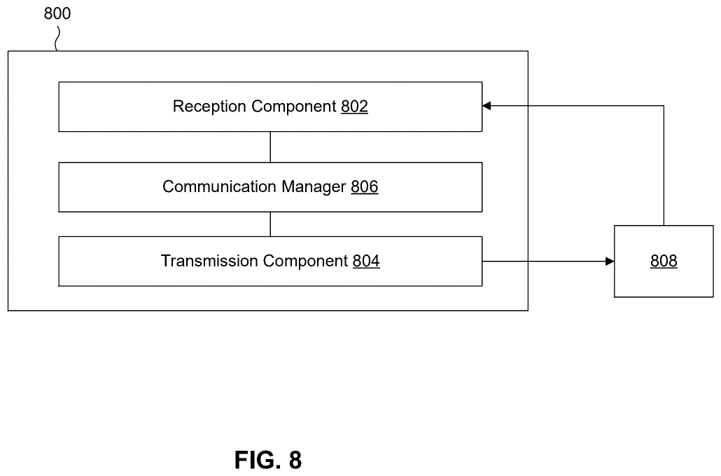

In some aspects, the UE 120 includes means for receiving a PDCCH transmission; and/or means for demodulating the PDCCH transmission in accordance with a BPSK modulation scheme based at least in part on the PDCCH transmission having an aggregation level that satisfies a threshold. The means for the UE 120 to perform operations described herein may include, for example, one or more of communication manager 150, processing system 140, a radio, one or more RF chains, one or more transceivers, one or more antennas, one or more modems, a reception component (for example, reception component 802 depicted and described in connection with FIG. 8), and/or a transmission component (for example, transmission component 804 depicted and described in connection with FIG. 8), among other examples.

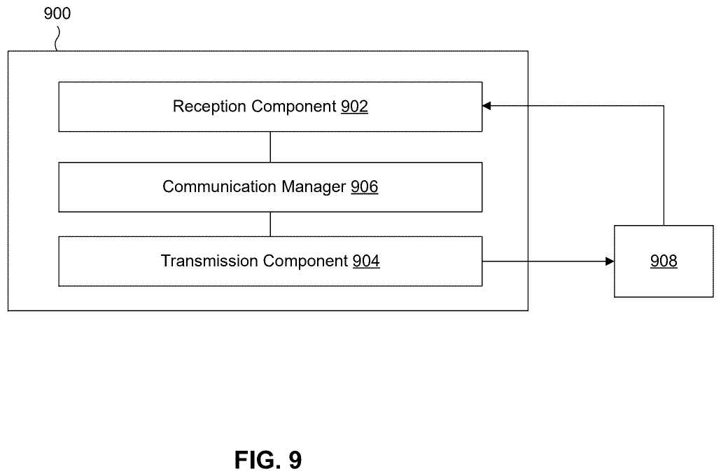

In some aspects, the network node 110 includes means for modulating a PDCCH transmission using BPSK modulation based at least in part on the PDCCH transmission having an aggregation level that satisfies a threshold; and/or means for transmitting the PDCCH transmission. The means for the network node 110 to perform operations described herein may include, for example, one or more of communication manager 155, processing system 145, a radio, one or more RF chains, one or more transceivers, one or more antennas, one or more modems, a reception component (for example, reception component 902 depicted and described in connection with FIG. 9), and/or a transmission component (for example, transmission component 904 depicted and described in connection with FIG. 9), among other examples.

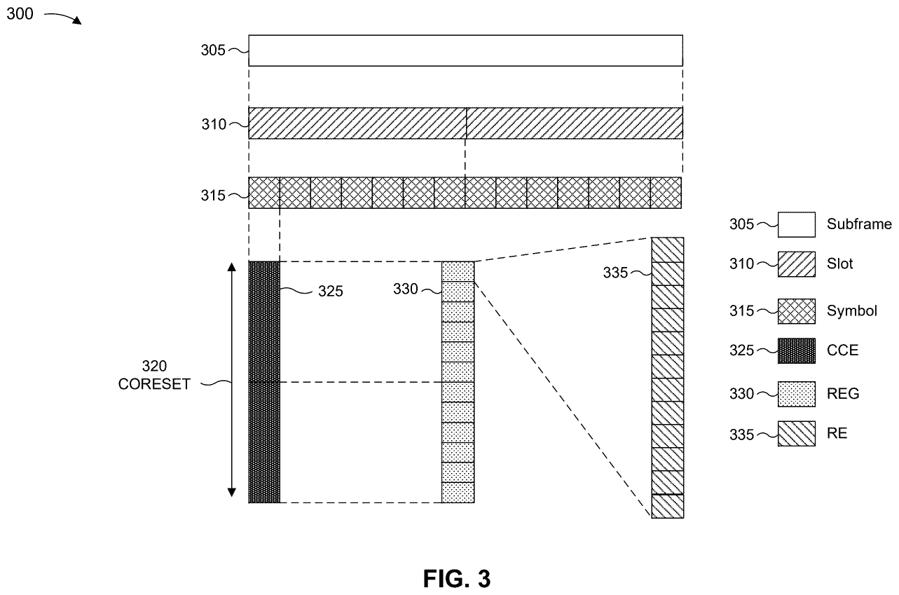

FIG. 3 is a diagram illustrating an example resource structure 300 for control channel transmissions, in accordance with the present disclosure. Resource structure 300 shows an example of various groups of resources described herein. As shown, resource structure 300 may include a subframe 305. Subframe 305 may include multiple slots 310. While resource structure 300 is shown as including 2 slots per subframe, a different number of slots may be included in a subframe (e.g., 4 slots, 8 slots, 16 slots, 32 slots, or another quantity of slots). In some aspects, different types of transmission time intervals (TTIs) may be used, other than subframes and/or slots. A slot 310 may include multiple symbols 315, such as 14 symbols per slot.

The potential control region of a slot 310 may be referred to as a control resource set (CORESET) 320 and may be structured to support an efficient use of resources, such as by flexible configuration or reconfiguration of resources of the CORESET 320 for one or more PDCCHs. In some aspects, the CORESET 320 may occupy the first symbol 315 of a slot 310, the first two symbols 315 of a slot 310, or the first three symbols 315 of a slot 310. Thus, a CORESET 320 may include multiple RBs in the frequency domain, and either one, two, or three symbols 315 in the time domain. In some aspects, a quantity of resources included in the CORESET 320 may be flexibly configured by a network node 110, such as by using RRC signaling to indicate a frequency domain region (e.g., a quantity of RBs) and/or a time domain region (e.g., a quantity of symbols) for the CORESET 320.

As illustrated, a symbol 315 that includes CORESET 320 may include one or more CCEs 325, shown as two CCEs 325 in FIG. 3, where the one or more CCEs 325 span a portion of the system bandwidth. A CCE 325 may include DCI that is used to provide control information for wireless communication. A network node 110 may transmit DCI to a UE 120 via multiple CCEs 325 (e.g., as shown in FIG. 3), where an AL associated with a PDCCH transmission represents the quantity of CCEs 325 used by the network node 110 for the transmission of DCI. In FIG. 3, an AL of two is shown, corresponding to two CCEs 325 in a slot 310. In some aspects, different ALs may be used, such as 1, 2, 4, 8, 16, or another AL.

Each CCE 325 may include a fixed quantity of REGs 330, such as six REGs 330, or may include a variable quantity of REGs 330. In some aspects, the quantity of REGs 330 included in a CCE 325 may be specified by an REG bundle size. An REG 330 may include one RB (or PRB), which corresponds to 12 REs 335 or subcarriers in one OFDM symbol 315. An RE 335 may occupy one subcarrier in the frequency domain and one OFDM symbol 315 in the time domain. Furthermore, an REG bundle may include multiple REGs 330 (e.g. two, three, or six REGs 330 for a distributed REG-to-CCE mapping), where a UE 120 may generally assume that the same precoder is used for the REGs 330 in an REG bundle and that the REGs 330 in an REG bundle are contiguous in frequency and/or time.

A search space may include all possible locations (e.g., in time and/or frequency) where a PDCCH may be located. A CORESET 320 may include one or more search spaces, such as a UE-specific search space, a group-common search space, and/or a common search space. A search space may indicate a set of CCE locations where a UE 120 may find PDCCHs that can potentially be used to transmit control information to the UE 120. The possible locations for a PDCCH may depend on whether the PDCCH is a UE-specific PDCCH (e.g., for a single UE 120) or a group-common PDCCH (e.g., for multiple UEs 120) and/or an AL being used for the PDCCH. A possible location (e.g., in time and/or frequency) for a PDCCH may be referred to as a PDCCH candidate, and the set of all possible PDCCH locations at an AL may be referred to as a search space. For example, the set of all possible PDCCH locations for a particular UE 120 may be referred to as a UE-specific search space. Similarly, the set of all possible PDCCH locations across all UEs 120 may be referred to as a common search space. The set of all possible PDCCH locations for a particular group of UEs 120 may be referred to as a group-common search space. One or more search spaces across aggregation levels may be referred to as a search space (SS) set.

A CORESET 320 may be interleaved or non-interleaved (e.g., a CCE 325 may be mapped to REGs 330 with interleaved or non-interleaved REG indexes within a CORESET 320). An interleaved CORESET 320 may have a CCE-to-REG mapping such that adjacent CCEs 325 are mapped to scattered REG bundles in the frequency domain (e.g., adjacent CCEs 325 are not mapped to consecutive REG bundles of the CORESET 320). For example, an interleaved CORESET 320 that spans one symbol 315 may have a CCE-to-REG mapping such that two or six REGs 330 for a given CCE 325 are grouped to form an REG bundle, and REG bundles are interleaved in the CORESET 320. Alternatively, for an interleaved CORESET 320 that spans two or three symbols 315, an REG bundle size may correspond to a number of REGs 330 in the frequency domain multiplied by a number of symbols 315 in the time domain (e.g., where the REG bundle in the time domain is equal to a semi-statically configured time duration of the CORESET 320), and a time-first mapping may be configured such that six REGs 330 for a given CCE 325 are grouped to form an REG bundle and all REGs 330 for a given CCE 325 are time and frequency localized. Alternatively, a non-interleaved CORESET 320 may have a CCE-to-REG mapping such that all CCEs 325 are mapped to consecutive REG bundles (e.g., in the frequency domain) of the CORESET 320. For example, a non-interleaved CORESET 320 that spans one symbol 315 may have a CCE-to-REG mapping in which six REGs 330 for a given CCE 325 are grouped to form an REG bundle, all REGs 330 for a given CCE 325 are consecutive, and CCEs 325 of one PDCCH are consecutive. Alternatively, a non-interleaved CORESET 320 that spans two or three symbols 315 may have a CCE-to-REG mapping in which six REGs 330 for a given CCE 325 are grouped to form an REG bundle and all REGs 330 for a given CCE 325 are time and frequency localized.

As described herein, a network node 110 may transmit a PDCCH to a UE 120 according to a one-port transmit diversity scheme with REG bundling. Furthermore, MU-MIMO may be supported using a non-orthogonal DMRS, and the PDCCH may be mapped contiguously or non-contiguously in a frequency domain with a localized or distributed CCE-to-REG mapping (in the physical domain). For each CORESET 320, a precoder granularity in the frequency domain may be configurable in a first mode (e.g., when the CORESET 320 is used for a PDCCH scheduling remaining minimum system information (RMSI)), where the precoder granularity is equal to the REG bundle size in the frequency domain. Alternatively, the precoder granularity may be configurable in a second mode, where the precoder granularity is equal to the quantity of contiguous RBs in the frequency domain within the CORESET 320. In the second mode, a DMRS may be mapped over all REGs 330 within the CORESET 320. Furthermore, in the second mode, a UE 120 may assume that the DMRS is present in all REGs 330 within the set of contiguous RBs of the CORESET 320 where and/or when at least one REG 330 of a PDCCH candidate is mapped.

As indicated above, FIG. 3 is provided as an example. Other examples may differ from what is described with respect to FIG. 3.

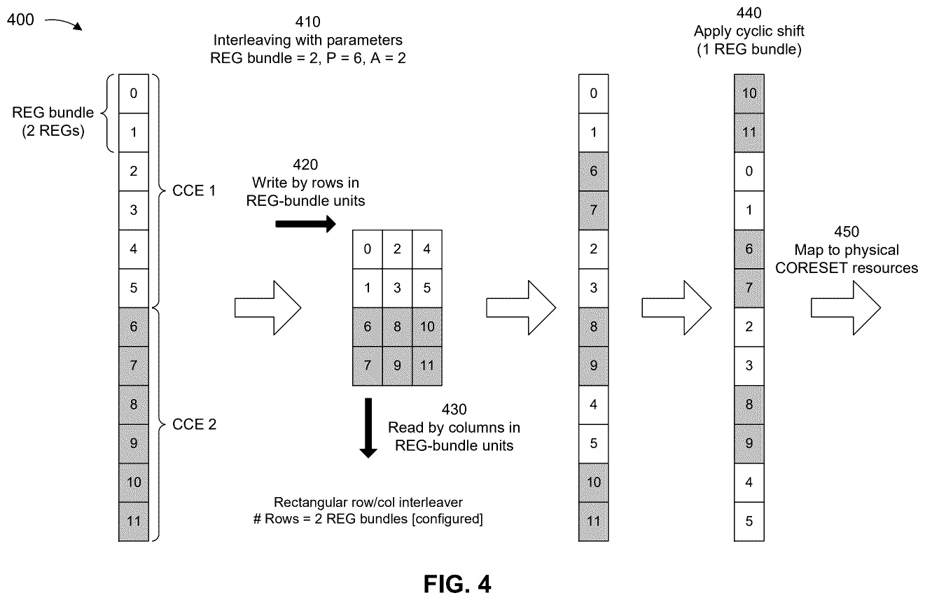

FIG. 4 is a diagram illustrating an example 400 of interleaving for control channel transmissions, in accordance with the present disclosure. For example, as described herein, a PDCCH may be transmitted using an interleaved CORESET with a CCE-to-REG mapping that maps adjacent CCEs to scattered REG bundles in the frequency domain (e.g., adjacent CCEs are not mapped to consecutive REG bundles).

For example, an interleaved CORESET that spans one symbol may have a CCE-to-REG mapping in which two or six REGs for a given CCE are grouped to form an REG bundle, and REG bundles are interleaved in the CORESET. Alternatively, for an interleaved CORESET that spans two or three symbols, an REG bundle size may correspond to a number of REGs in the frequency domain multiplied by a number of symbols in the time domain (e.g., where the REG bundle in the time domain is equal to a semi-statically configured time duration of the CORESET), and a time-first mapping may be configured such that six REGs for a given CCE are grouped to form an REG bundle and all REGs for a given CCE are time and frequency localized.

For example, FIG. 4 illustrates PDCCH interleaving using a row/column rectangular interleaver, where a set of parameters 410 associated with the row/column rectangular interleaver includes an REG bundle size of two (e.g., two REGs form an REG bundle), an interleaver unit is an REG bundle, the number of interleaving units for the CORESET, denoted P, is 6, the number of rows, denoted A, is 2 (where A may have a configured value of 2, 3, or 6), and the number of columns is given by P divided by A (e.g., 3 columns in FIG. 4, based on the row/column rectangular interleaver having 6 interleaving units and 2 rows). Accordingly, as shown in FIG. 4, PDCCH interleaving includes a first operation 420 where CCEs are written into the rectangular interleaver by rows in REG bundle units (e.g., such that a first three REG bundles, including CCEs 0 through 5, are written to a first row of the rectangular interleaver in REG bundle units, and a second three REG bundles, including CCEs 6 through 11, are written to a second row of the rectangular interleaver in REG bundle units). As further shown in FIG. 4, the PDCCH interleaving includes a second operation 430 where CCEs are read from the rectangular interleaver by columns in REG bundle units (e.g., such that a first REG bundle in the first column, including CCEs 0 and 1, are read from the rectangular interleaver first, a second REG bundle in the first column, including CCEs 6 and 7, are read from the rectangular interleaver second, and so on). As further shown in FIG. 4, a cyclic shift 440 of the interleaving unit may be applied based on a configurable identifier, which is independent from a configurable DMRS identifier. For example, the configurable identifier for the cyclic shift 440 may have a value in a range from 0 to 274 (e.g., the cyclic shift 440 applied in FIG. 4 is 1 REG bundle). For example, for a CORESET configured by a PBCH or RMSI, a physical cell identity (PCI) may be used as the cyclic shift 440 of the interleaving unit. As further shown, a mapping operation 450 may then be performed to map the CCEs to physical CORESET resources.

As indicated above, FIG. 4 is provided as an example. Other examples may differ from what is described with respect to FIG. 4.

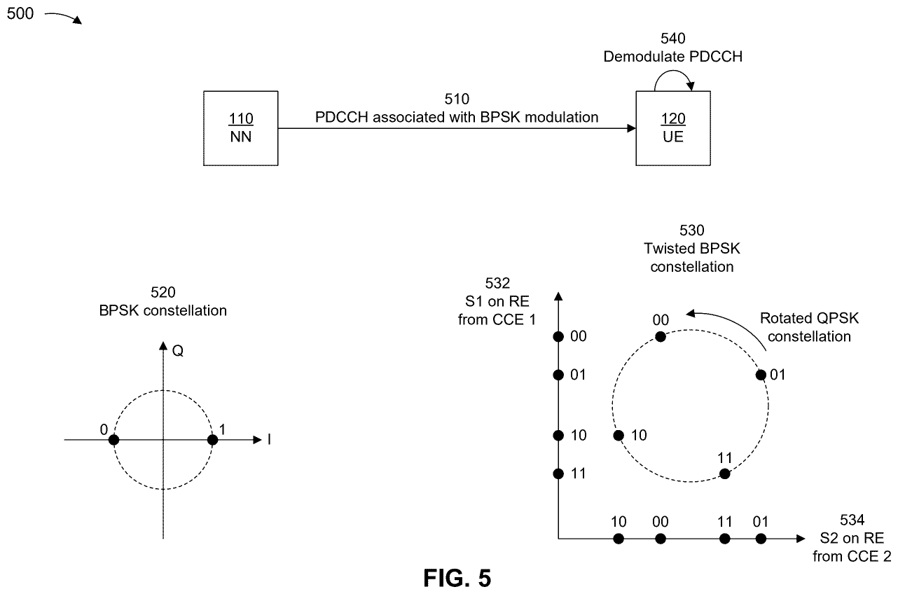

FIG. 5 is a diagram illustrating an example 500 of BPSK for control channel resilience against phase error, in accordance with the present disclosure. As shown in FIG. 5, example 500 includes communication between a network node 110 and a UE 120. In some aspects, the network node 110 and the UE 120 may be included in a wireless network, such as wireless network 100. The network node 110 and the UE 120 may communicate via a wireless access link, which includes an uplink and a downlink.

As described herein, wireless transmissions may be modulated using a modulation scheme, such as BPSK, QPSK, 16 QAM, 64 QAM, or 256 QAM, among other examples. Each modulation scheme is associated with a modulation order, often denoted Qm, which quantifies the capacity associated with a single modulation symbol. In other words, the modulation order, or Qm value, equals the number of source bits that can be transmitted per modulated symbol. For example, BPSK can be used to transmit one source bit per modulated symbol (Qm=1), QPSK can be used to transmit two source bits per modulated symbol (Qm=2), and 16 QAM can be used to transmit four source bits per modulated symbol (Qm=4), among other examples. Modulation schemes associated with higher modulation orders can be used to transmit relatively more bits per symbol, which can result in higher throughputs, but modulation schemes associated with higher modulation orders are also more susceptible to noise and interference. Accordingly, PUSCH and PDSCH transmissions support various modulation schemes (e.g., QPSK or higher), where high modulation orders may be used to achieve high throughputs in good coverage conditions, while low modulation orders may be used to maximize coverage or improve reliability in poor coverage conditions.

Furthermore, PDCCH transmissions are typically performed using QPSK to ensure reliable reception across an entire coverage area and to improve spectral efficiency by transmitting two bits per symbol (e.g., to efficiently and reliably convey signaling information without consuming significant bandwidth). For example, as described herein, a PDCCH transmission may include one or more CCEs, where each CCE includes six REGs and one REG is defined as one PRB, or 12 subcarriers, in one OFDM symbol. Accordingly, a PDCCH transmission may be associated with an AL, which generally corresponds to the number of CCEs in the PDCCH transmission, where up to 8 CCEs (e.g., a PDCCH transmission with an AL up to 8) can be encoded using a single polar code that provides FEC. For a PDCCH transmission with a larger AL (e.g., higher than 8), the PDCCH transmission may include multiple repetitions at an AL up to 8 (e.g., two repetitions at an AL of 8 may be used for PDCCH transmission with an AL of 16). For large ALs, which correspond to low coding rates, using repetitions and a smaller code block does not cause significant performance loss relative to using a single larger code block without repetitions.

However, when a high AL is used in a channel with a low SNR, there may be phase noise that results in non-ideal channel estimation that can degrade performance considerably. For example, non-ideal channel estimation can introduce phase error that may degrade PDCCH performance by about two to three dB, which can result in PDCCH decoding errors. Furthermore, the phase error has an adverse impact that generally depends on a distance between modulation points in phase. For example, in PSK modulation schemes such as BPSK, QPSK, and 8-PSK, modulation points are often represented on a constellation diagram in a complex plane, where a horizontal axis may represent a real or in-phase component of a signal and a vertical axis may represent an imaginary or quadrature component of the signal. The amplitude of each point along the in-phase axis is used to modulate a cosine wave, and the amplitude of each point along the quadrature axis is used to modulate a sine wave. The modulation points (or constellation points) are typically positioned with a uniform angular spacing around a circle centered at the intersection of the in-phase and quadrature axes, which provides a maximum separation between adjacent points and therefore a maximum resilience against phase error. Accordingly, because BPSK uses two phases separated by 180 degrees, and QPSK uses four phases separated by 90 degrees, BPSK can handle higher noise levels or distortion and provide better resilience against phase error than QPSK.

Accordingly, as shown reference number 510, the network node 110 may transmit, and the UE 120 may receive, a PDCCH transmission associated with a BPSK modulation scheme. In some aspects, the network node 110 may modulate the PDCCH transmission using the BPSK modulation scheme to reduce or otherwise mitigate adverse effects associated with channel estimation errors based at least in part on one or more parameters associated with the PDCCH transmission. For example, in some aspects, the PDCCH transmission may generally include DCI to convey control information to the UE 120, where the parameters associated with the PDCCH transmission may vary according to the control information to be conveyed to the UE 120. For example, in some aspects, the DCI may include a set of fields associated with a DCI format, which may be used to schedule a PUSCH transmission by the UE 120, to schedule a PDSCH transmission to the UE 120, to notify the UE 120 of a slot format, to notify the UE 120 about time and/or frequency resources where the UE 120 may assume that no transmission is intended for the UE 120, to indicate transmit power control (TPC) commands for PUCCH, PUSCH, and/or SRS transmissions, to notify the UE 120 about time and/or frequency resources where an uplink transmission from the UE 120 is cancelled, to notify the UE 120 about the availability of soft resources, to notify the UE 120 about power saving information outside a discontinuous reception (DRX) active time, and/or to schedule one or more sidelink transmissions. Accordingly, depending on the DCI to be transmitted and/or other factors, the network node 110 may configure one or more parameters associated with the PDCCH transmission (e.g., an AL, REG bundle size, channel estimation configuration, or the like) for the UE 120, and may use BPSK modulation for the PDCCH transmission to improve channel estimation performance for the PDCCH transmission when one or more conditions are satisfied.

For example, as shown in FIG. 5, a BPSK constellation 520 uses two phases, represented by two constellation points that are positioned on a circle and separated by 180 degrees. Although the two constellation points can be positioned anywhere on the circle, the BPSK constellation 520 shown in FIG. 5 positions the two constellation points on the real axis, at 0 degrees to represent a bit having a value of 1 and 180 degrees to represent a bit having a value of 0. Because the two constellation points in the BPSK constellation 520 are separated by 180 degrees in phase, a BPSK modulation scheme can provide better resilience against phase error than QPSK modulation associated with a constellation with four points separated by 90 degrees in phase. Accordingly, in some aspects, the network node 110 may modulate the PDCCH transmission using the BPSK modulation scheme based at least in part on the PDCCH transmission having an AL that satisfies (e.g., equals or exceeds) a threshold. For example, in some aspects, the threshold may have a fixed value that is specified in a wireless communication standard, or the threshold may have a value that is configured by the network node 110 (e.g., in a CORESET configuration and/or a search space configuration, among other examples).

Furthermore, in some aspects, the value of the threshold and/or the usage of BPSK modulation may depend on a DCI size associated with the PDCCH transmission. For example, a target SNR and/or an impact associated with phase noise may vary according to the DCI size, where a larger DCI size may generally result in a higher target SNR and/or an increased phase noise impact. Accordingly, the value of the threshold and/or the usage of BPSK modulation for the PDCCH transmission may depend on a DCI size associated with the PDCCH transmission. Additionally, or alternatively, the value of the threshold and/or the usage of BPSK modulation may depend on an REG bundle size associated with the PDCCH transmission. For example, variance in the REG bundle size may result in variance in the impact associated with phase noise or channel estimation noise. Accordingly, the value of the threshold and/or the usage of BPSK modulation may depend on the REG bundle size. Additionally, or alternatively, the value of the threshold and/or the usage of BPSK modulation may depend on a channel estimation configuration associated with the PDCCH transmission. For example, wideband channel estimation is performed based on all of the available channel bandwidth and is not dependent on an REG bundle size, such that wideband channel estimation may be more resilient against phase noise than narrowband channel estimation. Accordingly, in some aspects, the value of the threshold and/or the usage of BPSK modulation may depend on whether wideband channel estimation is used (e.g., the threshold may have a higher value or default QPSK modulation may be used when wideband channel estimation is configured, or the threshold may have a lower value or BPSK modulation may be used when wideband channel estimation is not configured).

In some aspects, rather than using a two-point BPSK constellation 520, the network node 110 may modulate the PDCCH transmission using a twisted BPSK constellation 530, which is analogous to a rotated QPSK constellation on two REs. For example, in order to provide frequency diversity with symbols that provide resilience against phase nose, the twisted BPSK constellation 530 includes four points that have a uniform angular spacing around a circle, where the circle is rotated such that the four points have different values on a real (in-phase) axis and different values on an imaginary (quadrature) axis. Accordingly, the four points may be projected onto a vertical axis and onto a horizontal axis as symbols that are transmitted on two REs associated with two different CCEs and/or two different REG bundles. For example, a shown in FIG. 5, a first symbol (S1) 532 may be transmitted on a first RE from a first CCE and/or a first REG bundle, and a second symbol (S2) 534 may be transmitted on a second RE from a second CCE and/or a second REG bundle. In this way, the twisted BPSK constellation 530 may be used to transmit the real and imaginary components of the rotated four-point (e.g., QPSK) constellation on different REs to provide frequency diversity and symbols with resilience against phase noise (e.g., because the symbols 532, 534 each become 4 pulse amplitude modulation (PAM) signals with phases that are all either 0 degrees or −180 degrees (e.g., with phases separated by 180 degrees).

Accordingly, in some aspects, the network node 110 may modulate the PDCCH transmission using the twisted BPSK constellation 530 based at least in part on the PDCCH transmission having an AL that satisfies (e.g., equals or exceeds) a threshold. For example, in a similar manner as the two-point BPSK constellation 520, the threshold may have a fixed value that is specified in a wireless communication standard, or the threshold may have a value that is configured by the network node 110 (e.g., in a CORESET configuration and/or a search space configuration, among other examples). Furthermore, in some aspects, the value of the threshold and/or the usage of BPSK modulation may depend on a DCI size associated with the PDCCH transmission, an REG bundle size associated with the PDCCH transmission, and/or a channel estimation configuration associated with the PDCCH transmission (e.g., depending on whether wideband channel estimation is configured). Furthermore, in some aspects, the twisted BPSK constellation 530 may be used with an interleaved PDCCH (e.g., as described with reference to FIG. 3 and/or FIG. 4), and/or may be conditioned on interleaving being configured for the PDCCH transmission.

Accordingly, as shown by reference number 540, the UE 120 may then demodulate the PDCCH transmission in accordance with the BPSK modulation scheme (e.g., based on the two-point BPSK constellation 520 that may be used to modulate one bit per symbol or based on the four-point twisted BPSK constellation 530 that may be used to modulate two symbols on different REs). For example, a unitary rotation of a multi-dimensional constellation (e.g., a four-point QPSK constellation) does not change resilience against channel estimation error, provided that the variance of the channel estimation error is similar for different REs and that the channel estimation noise is independent among different REs. For example, the unitary rotation does not change the resilience against channel estimation error because the overall multi-dimensional channel estimation noise vector for any constellation point has a circular distribution with a variance proportional to a squared norm of the constellation point. Furthermore, a unitary rotation does not change the squared norm of any constellation point or the distances between the constellation points. Accordingly, assuming independent and identically distributed channel estimation noise on different REs, the BPSK constellation 520 and the twisted BPSK constellation 530 may provide similar performance to QPSK. However, when channel estimation noise is not independent among different REs (e.g., channel estimation noise becomes highly dependent among adjacent REs, as may occur in a bad fading channel for an REG bundle that results in poor channel estimation performance for that REG bundle), the BPSK constellation 520 or the twisted BPSK constellation 530 can provide better performance than QPSK repetition. Furthermore, for a frequency selective channel, the twisted BPSK constellation 530 may exploit channel diversity by mixing two different channel gains and/or mixing the effects from two different levels of channel estimation noise.

As indicated above, FIG. 5 is provided as an example. Other examples may differ from what is described with respect to FIG. 5.

FIG. 6 is a diagram illustrating an example process 600 performed, for example, at a UE or an apparatus of a UE, in accordance with the present disclosure. Example process 600 is an example where the apparatus or the UE (e.g., UE 120) performs operations associated with BPSK for control channel resilience against phase error.

As shown in FIG. 6, in some aspects, process 600 may include receiving a PDCCH transmission (block 610). For example, the UE (e.g., using reception component 802 and/or communication manager 806, depicted in FIG. 8) may receive a PDCCH transmission, as described above.

As further shown in FIG. 6, in some aspects, process 600 may include demodulating the PDCCH transmission in accordance with a BPSK modulation scheme based at least in part on the PDCCH transmission having an aggregation level that satisfies a threshold (block 620). For example, the UE (e.g., using communication manager 806, depicted in FIG. 8) may demodulate the PDCCH transmission in accordance with a BPSK modulation scheme based at least in part on the PDCCH transmission having an aggregation level that satisfies a threshold, as described above.

Process 600 may include additional aspects, such as any single aspect or any combination of aspects described below and/or in connection with one or more other processes described elsewhere herein.

In a first aspect, the threshold is specified in a wireless communication standard.

In a second aspect, alone or in combination with the first aspect, process 600 includes receiving configuration information that indicates the threshold.

In a third aspect, alone or in combination with one or more of the first and second aspects, the threshold is based at least in part on a DCI size associated with the PDCCH transmission.

In a fourth aspect, alone or in combination with one or more of the first through third aspects, the threshold is based at least in part on an REG bundle size associated with the PDCCH transmission.

In a fifth aspect, alone or in combination with one or more of the first through fourth aspects, the threshold is based at least in part on a channel estimation bandwidth associated with the PDCCH transmission.

In a sixth aspect, alone or in combination with one or more of the first through fifth aspects, the PDCCH transmission is demodulated in accordance with the BPSK modulation scheme based at least in part on one or more of a DCI size, an REG bundle size, or a channel estimation bandwidth associated with the PDCCH transmission.

In a seventh aspect, alone or in combination with one or more of the first through sixth aspects, the BPSK modulation scheme is associated with a BPSK constellation having two points with phases separated by 180 degrees.

In an eighth aspect, alone or in combination with one or more of the first through seventh aspects, the BPSK modulation scheme is associated with a twisted BPSK constellation or a rotated QPSK constellation having four points that include respective real components received on a first RE with phases separated by 180 degrees and respective imaginary components received on a second RE with phases separated by 180 degrees.

In a ninth aspect, alone or in combination with one or more of the first through eighth aspects, the first RE is included in a first CCE and the second RE is included in a second CCE.

In a tenth aspect, alone or in combination with one or more of the first through ninth aspects, the first RE is included in a first REG bundle and the second RE is included in a second REG bundle.

In an eleventh aspect, alone or in combination with one or more of the first through tenth aspects, the BPSK modulation scheme is associated with the twisted BPSK constellation or the rotated QPSK constellation based at least in part on the PDCCH transmission having an interleaving configuration.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a network node or an apparatus of a network node, in accordance with the present disclosure. Example process 700 is an example where the apparatus or the network node (e.g., network node 110) performs operations associated with BPSK for control channel resilience against phase error.

As shown in FIG. 7, in some aspects, process 700 may include modulating a PDCCH transmission using BPSK modulation based at least in part on the PDCCH transmission having an aggregation level that satisfies a threshold (block 710). For example, the network node (e.g., using communication manager 906, depicted in FIG. 9) may modulate a PDCCH transmission using BPSK modulation based at least in part on the PDCCH transmission having an aggregation level that satisfies a threshold, as described above.

As further shown in FIG. 7, in some aspects, process 700 may include transmitting the PDCCH transmission (block 720). For example, the network node (e.g., using transmission component 904 and/or communication manager 906, depicted in FIG. 9) may transmit the PDCCH transmission, as described above.

Process 700 may include additional aspects, such as any single aspect or any combination of aspects described below and/or in connection with one or more other processes described elsewhere herein.

In a first aspect, the threshold is specified in a wireless communication standard.

In a second aspect, alone or in combination with the first aspect, process 700 includes transmitting configuration information that indicates the threshold.

In a third aspect, alone or in combination with one or more of the first and second aspects, the threshold is based at least in part on a DCI size associated with the PDCCH transmission.

In a fourth aspect, alone or in combination with one or more of the first through third aspects, the threshold is based at least in part on an REG bundle size associated with the PDCCH transmission.

In a fifth aspect, alone or in combination with one or more of the first through fourth aspects, the threshold is based at least in part on a channel estimation bandwidth associated with the PDCCH transmission.

In a sixth aspect, alone or in combination with one or more of the first through fifth aspects, the PDCCH transmission is modulated using the BPSK modulation based at least in part on one or more of a DCI size, an REG bundle size, or a channel estimation bandwidth associated with the PDCCH transmission.

In a seventh aspect, alone or in combination with one or more of the first through sixth aspects, the BPSK modulation is associated with a BPSK constellation having two points with phases separated by 180 degrees.

In an eighth aspect, alone or in combination with one or more of the first through seventh aspects, the BPSK modulation is associated with a twisted BPSK constellation or a rotated QPSK constellation having four points that include respective real components transmitted on a first RE with phases separated by 180 degrees and respective imaginary components transmitted on a second RE with phases separated by 180 degrees.

In a ninth aspect, alone or in combination with one or more of the first through eighth aspects, the first RE is included in a first CCE and the second RE is included in a second CCE.

In a tenth aspect, alone or in combination with one or more of the first through ninth aspects, the first RE is included in a first REG bundle and the second RE is included in a second REG bundle.

In an eleventh aspect, alone or in combination with one or more of the first through tenth aspects, the BPSK modulation is associated with the twisted BPSK constellation or the rotated QPSK constellation based at least in part on the PDCCH transmission having an interleaving configuration.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 150 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 140 described in connection with FIG. 1) of the UE.

In some aspects, the apparatus 800 may be configured to perform one or more operations described herein in connection with FIG. 5. Additionally, or alternatively, the apparatus 800 may be configured to perform one or more processes described herein, such as process 600 of FIG. 6. In some aspects, the apparatus 800 and/or one or more components shown in FIG. 8 may include one or more components of the UE described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the UE described above in connection with FIG. 1, such as a radio, one or more RF chains, one or more transceivers, or one or more modems, each of which may in turn be coupled with one or more antennas of the UE.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 804 may be co-located with the reception component 802.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The reception component 802 may receive a PDCCH transmission. The communication manager 806 may demodulate the PDCCH transmission in accordance with a BPSK modulation scheme based at least in part on the PDCCH transmission having an aggregation level that satisfies a threshold.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 155 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 145 described in connection with FIG. 1) of the network node.

In some aspects, the apparatus 900 may be configured to perform one or more operations described herein in connection with FIG. 5. Additionally, or alternatively, the apparatus 900 may be configured to perform one or more processes described herein, such as process 700 of FIG. 7. In some aspects, the apparatus 900 and/or one or more components shown in FIG. 9 may include one or more components of the network node described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the network node described above in connection with FIG. 1, such as a radio, one or more RF chains, one or more transceivers, or one or more modems, each of which may in turn be coupled with one or more antennas of the network node. In some aspects, the reception component 902 and/or the transmission component 904 may include or may be included in a network interface. The network interface may be configured to obtain and/or output signals for the apparatus 900 via one or more communications links, such as a backhaul link, a midhaul link, and/or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 904 may be co-located with the reception component 902.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The communication manager 906 may modulate a PDCCH transmission using BPSK modulation based at least in part on the PDCCH transmission having an aggregation level that satisfies a threshold. The transmission component 904 may transmit the PDCCH transmission.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:
Aspect 1: A method of wireless communication performed by a UE, comprising: receiving a PDCCH transmission; and demodulating the PDCCH transmission in accordance with a BPSK modulation scheme based at least in part on the PDCCH transmission having an aggregation level that satisfies a threshold.
Aspect 2: The method of Aspect 1, wherein the threshold is specified in a wireless communication standard.
Aspect 3: The method of any of Aspects 1-2, further comprising: receiving configuration information that indicates the threshold.
Aspect 4: The method of any of Aspects 1-3, wherein the threshold is based at least in part on a DCI size associated with the PDCCH transmission.
Aspect 5: The method of any of Aspects 1-4, wherein the threshold is based at least in part on an REG bundle size associated with the PDCCH transmission.
Aspect 6: The method of any of Aspects 1-5, wherein the threshold is based at least in part on a channel estimation bandwidth associated with the PDCCH transmission.
Aspect 7: The method of any of Aspects 1-6, wherein the PDCCH transmission is demodulated in accordance with the BPSK modulation scheme based at least in part on one or more of a DCI size, an REG bundle size, or a channel estimation bandwidth associated with the PDCCH transmission.
Aspect 8: The method of any of Aspects 1-7, wherein the BPSK modulation scheme is associated with a BPSK constellation having two points with phases separated by 180 degrees.
Aspect 9: The method of any of Aspects 1-8, wherein the BPSK modulation scheme is associated with a twisted BPSK constellation or a rotated QPSK constellation having four points that include respective real components received on a first RE with phases separated by 180 degrees and respective imaginary components received on a second RE with phases separated by 180 degrees.
Aspect 10: The method of Aspect 9, wherein the first RE is included in a first CCE and the second RE is included in a second CCE.
Aspect 11: The method of Aspect 9, wherein the first RE is included in a first REG bundle and the second RE is included in a second REG bundle.
Aspect 12: The method of Aspect 9, wherein the BPSK modulation scheme is associated with the twisted BPSK constellation or the rotated QPSK constellation based at least in part on the PDCCH transmission having an interleaving configuration.
Aspect 13: A method of wireless communication performed by a network node, comprising: modulating a PDCCH transmission using BPSK modulation based at least in part on the PDCCH transmission having an aggregation level that satisfies a threshold; and transmitting the PDCCH transmission.
Aspect 14: The method of Aspect 13, wherein the threshold is specified in a wireless communication standard.
Aspect 15: The method of any of Aspects 13-14, further comprising: transmitting configuration information that indicates the threshold.
Aspect 16: The method of any of Aspects 13-15, wherein the threshold is based at least in part on a DCI size associated with the PDCCH transmission.
Aspect 17: The method of any of Aspects 13-16, wherein the threshold is based at least in part on an REG bundle size associated with the PDCCH transmission.
Aspect 18: The method of any of Aspects 13-17, wherein the threshold is based at least in part on a channel estimation bandwidth associated with the PDCCH transmission.
Aspect 19: The method of any of Aspects 13-18, wherein the PDCCH transmission is modulated using the BPSK modulation based at least in part on one or more of a DCI size, an REG bundle size, or a channel estimation bandwidth associated with the PDCCH transmission.
Aspect 20: The method of any of Aspects 13-19, wherein the BPSK modulation is associated with a BPSK constellation having two points with phases separated by 180 degrees.
Aspect 21: The method of any of Aspects 13-20, wherein the BPSK modulation is associated with a twisted BPSK constellation or a rotated QPSK constellation having four points that include respective real components transmitted on a first RE with phases separated by 180 degrees and respective imaginary components transmitted on a second RE with phases separated by 180 degrees.
Aspect 22: The method of Aspect 21, wherein the first RE is included in a first CCE and the second RE is included in a second CCE.
Aspect 23: The method of Aspect 21, wherein the first RE is included in a first REG bundle and the second RE is included in a second REG bundle.
Aspect 24: The method of Aspect 21, wherein the BPSK modulation is associated with the twisted BPSK constellation or the rotated QPSK constellation based at least in part on the PDCCH transmission having an interleaving configuration.
Aspect 25: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-24.
Aspect 26: An apparatus for wireless communication at a device, the apparatus comprising one or more memories and one or more processors coupled to the one or more memories, the one or more processors configured to cause the device to perform the method of one or more of Aspects 1-24.
Aspect 27: An apparatus for wireless communication, the apparatus comprising at least one means for performing the method of one or more of Aspects 1-24.
Aspect 28: A non-transitory computer-readable medium storing code for wireless communication, the code comprising instructions executable by one or more processors to perform the method of one or more of Aspects 1-24.
Aspect 29: A non-transitory computer-readable medium storing a set of instructions for wireless communication, the set of instructions comprising one or more instructions that, when executed by one or more processors of a device, cause the device to perform the method of one or more of Aspects 1-24.
Aspect 30: A device for wireless communication, the device comprising a processing system that includes one or more processors and one or more memories coupled with the one or more processors, the processing system configured to cause the device to perform the method of one or more of Aspects 1-24.
Aspect 31: An apparatus for wireless communication at a device, the apparatus comprising one or more memories and one or more processors coupled to the one or more memories, the one or more processors individually or collectively configured to cause the device to perform the method of one or more of Aspects 1-24.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one. ” Further, as used herein, the article “the” is intended to include one or more items referenced in connection with the article “the” and may be used interchangeably with “the one or more. ” Furthermore, as used herein, the terms “set” and “group” are intended to include one or more items and may be used interchangeably with “one or more. ” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A method of wireless communication performed by a user equipment (UE), comprising:
receiving a physical downlink control channel (PDCCH) transmission; and
demodulating the PDCCH transmission in accordance with a binary phase shift keying (BPSK) modulation scheme based at least in part on the PDCCH transmission having an aggregation level that satisfies a threshold.

2. The method of claim 1, wherein the threshold is specified in a wireless communication standard.

3. The method of claim 1, further comprising:
receiving configuration information that indicates the threshold.

4. The method of claim 1, wherein the threshold is based at least in part on a downlink control information (DCI) size associated with the PDCCH transmission.

5. The method of claim 1, wherein the threshold is based at least in part on a resource element group (REG) bundle size associated with the PDCCH transmission.

6. The method of claim 1, wherein the threshold is based at least in part on a channel estimation bandwidth associated with the PDCCH transmission.

7. The method of claim 1, wherein the PDCCH transmission is demodulated in accordance with the BPSK modulation scheme based at least in part on one or more of a downlink control information (DCI) size, a resource element group (REG) bundle size, or a channel estimation bandwidth associated with the PDCCH transmission.

8. The method of claim 1, wherein the BPSK modulation scheme is associated with a BPSK constellation having two points with phases separated by 180 degrees.

9. The method of claim 1, wherein the BPSK modulation scheme is associated with a twisted BPSK constellation or a rotated quadrature phase shift keying (QPSK) constellation having four points that include respective real components received on a first resource element (RE) with phases separated by 180 degrees and respective imaginary components received on a second RE with phases separated by 180 degrees.

10. The method of claim 9, wherein the first RE is included in a first control channel element (CCE) and the second RE is included in a second CCE.

11. The method of claim 9, wherein the first RE is included in a first resource element group (REG) bundle and the second RE is included in a second REG bundle.

12. The method of claim 9, wherein the BPSK modulation scheme is associated with the twisted BPSK constellation or the rotated QPSK constellation based at least in part on the PDCCH transmission having an interleaving configuration.

13. A method of wireless communication performed by a network node, comprising:
modulating a physical downlink control channel (PDCCH) transmission using binary phase shift keying (BPSK) modulation based at least in part on the PDCCH transmission having an aggregation level that satisfies a threshold; and
transmitting the PDCCH transmission.

14. The method of claim 13, wherein the threshold is specified in a wireless communication standard.

15. The method of claim 13, further comprising:
transmitting configuration information that indicates the threshold.

16. The method of claim 13, wherein the threshold is based at least in part on a downlink control information (DCI) size associated with the PDCCH transmission.

17. The method of claim 13, wherein the threshold is based at least in part on a resource element group (REG) bundle size associated with the PDCCH transmission.

18. The method of claim 13, wherein the threshold is based at least in part on a channel estimation bandwidth associated with the PDCCH transmission.

19. The method of claim 13, wherein the PDCCH transmission is modulated using the BPSK modulation based at least in part on one or more of a downlink control information (DCI) size, a resource element group (REG) bundle size, or a channel estimation bandwidth associated with the PDCCH transmission.

20. The method of claim 13, wherein the BPSK modulation is associated with a BPSK constellation having two points with phases separated by 180 degrees.

21. The method of claim 13, wherein the BPSK modulation is associated with a twisted BPSK constellation or a rotated quadrature phase shift keying (QPSK) constellation having four points that include respective real components transmitted on a first resource element (RE) with phases separated by 180 degrees and respective imaginary components transmitted on a second RE with phases separated by 180 degrees.

22. The method of claim 21, wherein the first RE is included in a first control channel element (CCE) and the second RE is included in a second CCE.

23. The method of claim 21, wherein the first RE is included in a first resource element group (REG) bundle and the second RE is included in a second REG bundle.

24. The method of claim 21, wherein the BPSK modulation is associated with the twisted BPSK constellation or the rotated QPSK constellation based at least in part on the PDCCH transmission having an interleaving configuration.

25. A user equipment (UE) for wireless communication, comprising:
one or more memories; and
one or more processors, coupled to the one or more memories, configured to cause the UE to:
receive a physical downlink control channel (PDCCH) transmission; and
demodulate the PDCCH transmission in accordance with a binary phase shift keying (BPSK) modulation scheme based at least in part on the PDCCH transmission having an aggregation level that satisfies a threshold.

26. The UE of claim 25, wherein the threshold is specified in a wireless communication standard or indicated in configuration information received from a network node.

27. The UE of claim 25, wherein the threshold is based at least in part on a downlink control information (DCI) size, a resource element group (REG) bundle size, or a channel estimation bandwidth associated with the PDCCH transmission.

28. The UE of claim 25, wherein the PDCCH transmission is demodulated in accordance with the BPSK modulation scheme based at least in part on one or more of a downlink control information (DCI) size, a resource element group (REG) bundle size, or a channel estimation bandwidth associated with the PDCCH transmission.

29. The UE of claim 25, wherein the BPSK modulation scheme is associated with a BPSK constellation having two points with phases separated by 180 degrees or a twisted BPSK constellation or a rotated quadrature phase shift keying (QPSK) constellation having four points that include respective real components received on a first resource element (RE) with phases separated by 180 degrees and respective imaginary components received on a second RE with phases separated by 180 degrees.

30. A network node for wireless communication, comprising:
one or more memories; and
one or more processors, coupled to the one or more memories, configured to cause the network node to:
modulate a physical downlink control channel (PDCCH) transmission using binary phase shift keying (BPSK) modulation based at least in part on the PDCCH transmission having an aggregation level that satisfies a threshold; and
transmit the PDCCH transmission.
